(19) United States
(12) Patent Application Publication
(10) Pub. No.: US 2006/0011063 A1
(43) Pub. Date: Jan. 19, 2006

(54) High temperature gas separation membrane suitable for OBIGGS applications

(75) Inventor: Shaojun J. Zhou, Palatine, IL (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 10/892,881

(22) Filed: Jul. 16, 2004

(51) Int. Cl. B01D 53/22

(52) U.S. Cl. 96/10

(57) ABSTRACT

Gas separation membranes and methods for preparing such membranes. The gas separation membranes of the instant invention can separate oxygen and nitrogen in air to provide nitrogen enriched air (NEA), and are stable during exposure to temperatures of at least about 160° C. The gas separation membranes of the instant invention may be formed from polyetherimide by extruding a hollow fiber using a core liquid, quenching the extruded fiber in dry air to promote loss of solvent and non-solvent, and drying the fiber. Methods for separating bleed air fed directly from an aircraft precooler to a high temperature gas separation hollow fiber membrane, to provide NEA, are also disclosed.

### BACKGROUND OF THE INVENTION

The present invention generally relates to gas separation membranes, and to methods for preparing such membranes.

Separation of gaseous components of a gas mixture may be achieved by various processes, including pressure swing adsorption, cryogenics, and membrane separation. Membrane separations are based on the relative permeability of the various gaseous components in the gas mixture to be separated through the membrane material. For example, in the case of separation of gaseous components of air, separation may be based on the relative permeability of the membrane to oxygen and nitrogen.

Aircraft manufacturers are becoming increasingly sensitive to the risks associated with the composition of fuel tank ullage. This is due to risk of flame propagation or explosion when a mixture of fuel vapors and air occupy fuel tank ullage, for example, as fuel is consumed during flight. The risk of explosion can be greatly decreased by providing nitrogen enriched air (NEA) to render the fuel tank ullage “inert.” Currently, there are no fuel tank inerting requirements for commercial aircraft. However, the FAA is expected to make fuel tank inerting a requirement for commercial aircraft later in 2004.

Military aircraft have used stored liquid nitrogen bottles, halon systems, or onboard inert gas generating systems based on pressure swing adsorption technology for inerting their fuel tanks. Each of these approaches has proved costly to operate or is being eliminated due to environmental concerns. Onboard systems could provide inert gas throughout the flight of commercial as well as military aircraft to eliminate exposure to flammable fuel tank ullage. Onboard Inert Gas Generating Systems (OBIGGS) separate nitrogen from engine bleed air or other compressed air onboard aircraft. OBIGGS based on permeable gas separation membranes are completely passive; they rely on polymer membranes to separate air into a nitrogen enriched stream (comprising NEA) and a nitrogen-depleted stream. Such systems exist on some military aircraft today, notably the C-17, as well as some fighters and helicopters.

Gas separation membranes are commercially available, for example, in the form of hollow fibers. Hollow fiber gas separation membranes formed from various organic polymers, such as polycarbonates, are disclosed in U.S. Pat. No. 4,955,993 to Sanders et al. The gas separation membranes disclosed by Sanders et al. are formed using a core gas during extrusion of the hollow fiber. The hollow fiber membranes of Sanders et al. have an external porous region and a discriminating region at or near the internal surface of the fiber.

Conventional gas separation membranes have a maximum operating temperature of about 90° C. Such gas separation membranes cannot withstand exposure to bleed air fed to an OBIGGS. Even after passage through a precooler, or primary heat exchanger, bleed air from a gas turbine engine of an aircraft is typically at a temperature substantially above 90° C. Accordingly, further cooling of air to be fed to the OBIGGS may be necessary, for example, using one or more heat exchangers in addition to the precooler.

As can be seen, there is a need for a gas separation membrane that can be used to provide a stream of NEA and which is heat stable. There is a further need for a gas separation membrane that can be used for the efficient separation of bleed air fed to the membrane over a broader temperature range using simple, robust control of bleed air temperature.

### SUMMARY OF THE INVENTION

In one aspect of the present invention, there is provided a method for preparing a high temperature gas separation membrane comprising preparing a mixture, wherein the mixture comprises a polymer, a solvent, and a non-solvent; forming a hollow fiber from the mixture; and feeding a core liquid within the bore of the hollow fiber. The membrane is heat stable to a temperature of at least about 160° C., and the membrane has an oxygen/nitrogen selectivity of at least about 2.

In another aspect of the present invention, a method for preparing a high temperature gas separation membrane comprises preparing a mixture, wherein the mixture comprises polyetherimide, a solvent, and a non-solvent; extruding the mixture through an annulus of an extrusion die to form a hollow fiber comprising the polyetherimide; feeding a core liquid within the bore of the hollow fiber, wherein the core liquid is N-methyl pyrrolidone/water or N-methyl pyrrolidone/triethylene glycol; passing the hollow fiber through a gaseous quench zone of dry air at ambient temperature; passing the hollow fiber through a liquid quench zone; boiling the hollow fiber in water; and drying the hollow fiber. The gas separation membrane so prepared is heat stable at a temperature of at least about 160° C.

In still another aspect of the present invention, there is provided a method for preparing a high temperature gas separation membrane comprising preparing a mixture including polyetherimide, a solvent, and a non-solvent; extruding the mixture through an annulus of an extrusion die to form a hollow fiber comprising the polyetherimide; concurrently with the extruding step, feeding a core liquid within the annulus, such that the core liquid enters the bore of the hollow fiber and the core liquid contacts the internal surface of the hollow fiber; passing the hollow fiber through a gaseous quench zone of dry air at ambient temperature, wherein the gaseous quench zone is adapted to promote loss of both the solvent and the non-solvent from the external surface of the hollow fiber; thereafter, passing the hollow fiber through a liquid quench zone of water at ambient temperature; washing the hollow fiber with water; thereafter, boiling the hollow fiber in water; pre-drying the hollow fiber at a first temperature; and drying the hollow fiber at a second temperature, the second temperature being higher than the first temperature. The walls of the hollow fiber comprise the gas separation membrane, the gas separation membrane has an inner porous layer and an outer non-porous layer. The gas separation membrane is heat stable to a temperature of at least about 160° C., and the gas separation membrane has an oxygen/nitrogen selectivity of at least about 4.

In yet another aspect of the present invention, a method for treating a hollow fiber gas separation membrane comprises feeding a core liquid within the bore of the hollow fiber; quenching the hollow fiber; boiling the hollow fiber in water; pre-drying the hollow fiber at a first temperature above ambient temperature; and drying the hollow fiber at a second temperature. The first temperature is less than the second temperature, and the gas separation membrane is heat stable to a temperature of at least about 160° C.

In an additional aspect of the present invention, there is provided a high temperature gas separation membrane comprising at least one hollow fiber, wherein the hollow fiber includes a non-porous external layer and a porous internal layer. The gas separation membrane has an oxygen/nitrogen selectivity of at least about 4, and an oxygen flux of at least about 2 GPU. The gas separation membrane is heat stable to a temperature of at least about 160° C. for a period of at least about 34 days.

In a further aspect of the present invention, a method for separating gas via a high temperature gas separation membrane of an OBIGGS comprises feeding bleed air to the gas separation membrane of the OBIGGS to provide a product stream and a permeate stream; and collecting the product stream separately from the permeate stream, wherein the bleed air is obtained from a gas turbine engine. The gas separation membrane has an oxygen/nitrogen selectivity of at least about 4, and an oxygen flux of at least about 2 GPU. The gas separation membrane is heat stable at a temperature of at least about 160° C.

These and other features, aspects, and advantages of the present invention will become better understood with reference to the following drawings, description, and claims.

### BRIEF DESCRIPTION OF THE DRAWINGS

FIG. 1 schematically represents a series of steps involved in a method for preparing a high temperature gas separation membrane, according to one embodiment of the invention;

FIG. 2 schematically represents a series of steps involved in a method for treating an extruded hollow fiber gas separation membrane, according to another embodiment of the invention;

FIG. 3 schematically represents a series of steps involved in a method for preparing a high temperature gas separation membrane, according to another embodiment of the invention;

FIG. 4 schematically represents a series of steps involved in a method for separating gaseous components of a gas, according to another embodiment of the invention;

FIG. 5A is a graph showing flow rate for a hollow fiber membrane during exposure to a temperature of 160° C.; and

FIG. 5B is a graph showing oxygen concentrations for inlet gas, product gas, and permeate gas during exposure of a hollow fiber membrane to a temperature of 160° C.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides gas separation membranes, and methods for preparing such membranes. The gas separation membranes prepared according to the instant invention have the ability to separate oxygen and nitrogen in air to provide nitrogen enriched air (NEA) during exposure to high temperatures, such as may be experienced when the gas separation membranes are exposed to bleed air from a gas turbine engine of an aircraft. The gas separation membranes of the instant invention may be used in onboard inert gas generating systems (OBIGGS) to provide NEA for inerting fuel tank ullage in both commercial and military aircraft.

In contrast to prior art processes for preparing hollow fiber gas separation membranes, methods for preparing hollow fiber membranes of the instant invention may involve feeding a core liquid at a defined rate to the hollow fiber, which may be extruded from an annulus having an outside diameter to inside diameter ratio typically in the range of from about 1.1 to 2.5, and usually from about 1.5 to 2.0. Prior art processes have used various core gases during extrusion of fibers from an annulus having an outside diameter to inside diameter ratio of about 7. Processes of the invention, may involve passing the extruded fiber through a gaseous quench zone adapted to maximize loss of solvent and non-solvent from the hollow fiber. In contrast, prior art processes have used quench zones which minimize loss of solvent and non-solvent from the hollow fiber. Processes of the invention may also include other process steps which, alone or in combination, distinguish processes of the invention from various prior art processes.

In contrast to prior art gas separation membranes for production of NEA, membranes prepared according to the instant invention are heat stable, and retain their ability to separate oxygen from nitrogen in air during exposure to a temperature of at least about 160° C. for a period of at least about 34 days. Currently available commercial gas separation membranes of the prior art are destroyed by temperatures in excess of about 90° C. The lower operating temperature of prior art membranes requires the use of heat exchangers to cool the inlet air fed to heat labile prior art membranes. Unlike prior art gas separation membranes, membranes of the instant invention may be installed in an air separation module (ASM) of an OBIGGS and exposed directly to bleed air at a temperature of at least about 160° C. Thus, the higher operating temperatures of gas separation membranes of the instant invention may reduce or eliminate the need for heat exchanger components in the OBIGGS, thereby reducing the size, weight, and complexity of the OBIGGS.

Of course, depending on the desired OBIGGS configuration and other considerations, gas separation membranes of the instant invention may, optionally be incorporated in an OBIGGS which includes one or more heat exchangers.

High temperature gas separation membranes of the instant invention may possess numerous other advantages over low temperature membranes of the prior art. Permeation rate increases exponentially with increase in temperature. Accordingly, due to the increased operating temperatures of gas separation membranes of the instant invention, permeation rates of up to about one order of magnitude greater than those of commercially available state-of-the-art membranes may be attained. As a result of the increased permeation rates attainable with membranes of the instant invention, the size and weight of the ASM may be greatly reduced, thereby reducing the size and weight of the OBIGGS. In addition, hollow fiber membranes of the instant invention are suitable for both internal (boreside) and external gas feed operation modes.

Gas separation membranes of the instant invention comprising, for example, polyetherimide hollow fibers, also offer the advantages of being sufficiently robust to withstand normal handling, chaffing, and vibration; and resistance to chemical contaminants that may be encountered in gas turbine engine bleed air. Polyetherimide hollow fibers of the instant invention may also exhibit chemical compatibility with high temperature-cure potting compounds, which may be used in the manufacture of tube-and-shell ASMs incorporating such hollow fibers.

FIG. 1 schematically represents a series of steps involved in a method 100 for preparing a high temperature gas separation membrane, according to one embodiment of the invention. Step 102 may involve forming a mixture comprising (i) a polymer, (ii) a solvent for the polymer, and (iii) a non-solvent for the polymer. The polymer may be a high temperature, hydrophobic polymer such as a polyetherimide. The solvent may be a hydrophobic (lipophilic) liquid such as N-methylpyrrolidone (NMP). The non-solvent may be a liquid such as water, triethylene glycol (TEG), acetic acid, or ethanol. The mixture may be formulated such that the wt % ratio of solvent to non-solvent is in the range of typically from about 2:8, usually about 3:6, and often about 3:5.

The components of the mixture may be mixed, shaken, stirred, or otherwise agitated, and may be heated to a temperature above ambient temperature. For example, the mixture may be stirred or shaken at a temperature in the range of from about 60 to 95° C., usually from about 70 to 90° C., and often from about 70 to 85° C. Shaking or stirring of the mixture may be continued for a period of up to about 48 hours or more. Shaking or stirring of the mixture may be continued until complete dissolution of the polymer occurs.

Step 104 may involve forming a hollow fiber from the mixture prepared in step 102. The hollow fiber may be formed by extrusion through an annular extrusion die or spinnerette. Extrusion dies for forming hollow fibers are known in the art. The mixture may be de-bubbled prior to extrusion of the hollow fiber. Prior to extrusion, the mixture may be held in a pressure vessel under inert gas pressure. Typically, the pressure in the pressure vessel may be in the range of from about 50 to 500 psig, usually from about 90 to 300 psig, and often from about 100 to 250 psig. During extrusion of the hollow fiber, the mixture may be fed from the pressure vessel to the extrusion die at a rate typically in the range of from about 0.5 to 4 gram per minute (g/min), usually from about 1 to 3 g/min, and often from about 1 to 2.5 g/min. The mixture can also be extruded using a twin or single screw extruder, a gear pump, or other devices that can pump the viscous mixture to the spinnerette.

During extrusion of the hollow fiber, the mixture in the pressure vessel and in the line to the extrusion die may be maintained at a temperature typically in the range of from about ambient temperature to about 110° C., usually from about 60 to 90° C., and often from about 70 to 90° C. During extrusion of the hollow fiber, the extrusion die itself may be maintained at a temperature typically in the range of from about 60 to 110° C., usually from about 70 to 100° C., and often from about 70 to 90° C.

Step 106 may involve feeding a core liquid within the hollow fiber. The core liquid may be fed within the hollow fiber concurrently with, or immediately after, extrusion of the hollow fiber. The core liquid may be fed within the hollow fiber such that the core liquid contacts the internal surface of the hollow fiber. The core liquid may be fed within the hollow fiber by feeding the core liquid via a core fluid pin from within the annulus of the extrusion die. The core liquid may be fed within the hollow fiber at a carefully controlled rate. Typically, the rate of feeding the core liquid within the hollow fiber may be in the range of from about 0.1 to 2.5 ml per minute (ml/min.), usually from about 0.5 to 1.5 ml/min., and often from about 0.5 to 1 ml/min.

The core liquid may comprise a liquid such as methanol, ethanol, propanol, ethylene glycol, glycerol, triethylene glycol (TEG), tetra-ethylene glycol, or other water soluble alcohols, dimethylformamide, dimethylacetamide, acetone, tetrahydrofuran, water, NMP, or mixtures thereof. Typically, the core liquid may comprise a mixture of NMP with a second liquid such as water (NMP/water), TEG (NMP/TEG), or ethanol (NMP/ethanol). The wt % ratio of NMP to the second liquid may typically be in the range of from about 99:1 to 50:50, and usually from about 95:5 to 50:50. For example, the core liquid may comprise a 50:50 mixture of NMP/TEG by weight, or a 90:10 mixture of NMP/water by weight.

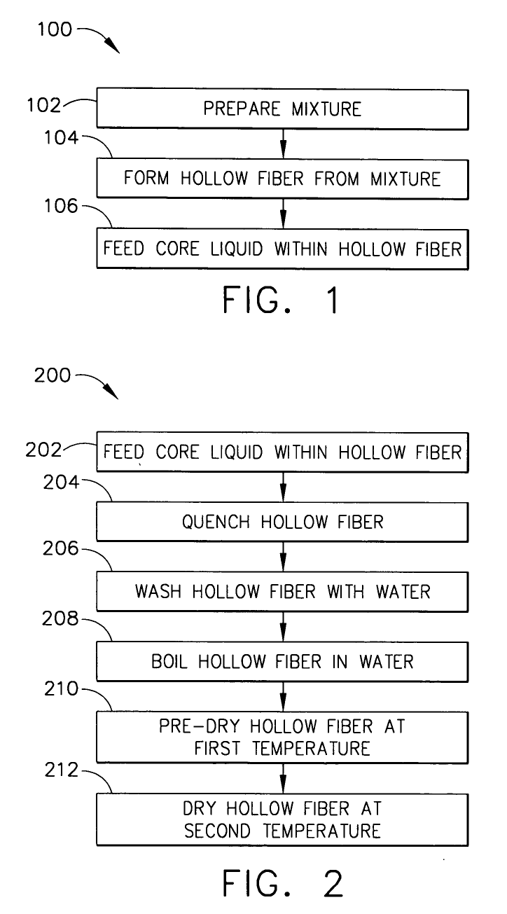

After extrusion, the hollow fiber may be treated (see, for example, FIG. 2) to form a gas separation membrane of the instant invention, wherein the gas separation membrane may comprise the walls of the hollow fiber.

FIG. 2 schematically represents a series of steps involved in a method 200 for treating an extruded hollow fiber gas separation membrane, according to one embodiment of the invention. Step 202 may involve feeding a core liquid within the hollow fiber. The core liquid may be fed within the hollow fiber essentially as described hereinabove, for example, with reference to FIG. 1. As an example, the core liquid may be fed within the hollow fiber at a controlled flow rate concurrently with, or immediately after, extrusion of the hollow fiber.

Step 204 may involve quenching the extruded hollow fiber. Quenching may cause a phase transition, or phase inversion, of the follow fiber from a gel to a solid state. Step 204 may involve passing the hollow fiber through both a gaseous quench zone and a liquid quench zone (see, for example, FIG. 3). Passing the hollow fiber through both a gaseous quench zone and a liquid quench zone may remove solvent and non-solvent from the hollow fiber membrane, and may result in the formation of pores in a porous layer of the membrane. Step 204 may result in the formation of the structure of the hollow fiber membrane. For example, step 204 may result in the formation of both the internal porous layer and the external, non-porous (skin) layer.

Step 206 may involve washing or rinsing the hollow fiber with water. The hollow fiber may be wound on a spool prior to washing with water. Step 206 may help to remove traces of both solvent and non-solvent from the hollow fiber. The hollow fiber may be washed with tap water for a period of time longer than about 1 hour, and in some embodiments up to about 12 hours or longer.

Step 208 may involve boiling the hollow fiber in water. The hollow fiber may be boiled in deionized water. Step 208 may involve boiling the hollow fiber in water for a period in the range of from about 1 to 20 minutes, typically from about 5 to 15 minutes, and often about 10 minutes.

After boiling the hollow fiber in water, step 210 may involve pre-drying the hollow fiber. Step 210 may be performed in an oven, for example, at a first temperature above ambient temperature. As an example, step 210 may be performed at a temperature of about 90° C. Typically, step 210 may be performed for a period of time in the range of from about 30 minutes to 3 hours, usually about 1 to 2.5 hours, and often about 2 hours.

After step 210, step 212 may involve drying the hollow fiber. Step 212 may be performed at a second temperature, wherein the second temperature may be higher than the first temperature of step 210. Step 212 may involve drying the hollow fiber at a temperature in the range of from about 150 to 160° C., and typically about 160° C. Step 212 may remove water from the hollow fiber. Step 212 may also stabilize the structure of both the internal porous layer and the external, non-porous (skin) layer. While not being bound by theory, applicant believes that drying the hollow fiber at a temperature above the boiling point of water, for example about 160° C., may be an important factor in stabilizing the structure of both porous and non-porous (skin) layers of the hollow fiber walls (i.e., membrane), thereby contributing to, or bestowing, the heat stable characteristics of the hollow fiber membranes of the instant invention. In describing gas separation membranes of the present invention, the expression “heat stable” may be construed as having the ability to withstand exposure to a temperature of at least about 160° C. (the highest temperature tested) for a period of at least about 34 days (the longest period tested at 160° C.). Step 212 may provide a polyetherimide hollow fiber gas separation membrane devoid of water.

After drying, the hollow fibers may be potted with epoxy materials into a tube-and-shell style ASM. Such tube-and-shell structures, in general, are known in the art. The resultant ASM may be used for separation of engine bleed air fed directly to the ASM from an aircraft precooler at a temperature of up to at least about 160° C. In the event of transient excessively high temperature conditions of air flowing from the precooler (e.g., ≧260° C.), the ASM may be temporarily shut down until normal temperature conditions, e.g., 150 to 160° C., are restored.

FIG. 3 schematically represents a series of steps involved in a method for preparing a high temperature gas separation membrane, according to another embodiment of the invention. Step 302 may involve preparing a polymer mixture. The polymer mixture may be prepared essentially as described hereinabove, e.g., with reference to step 102, method 100 (FIG. 1).

Step 304 may involve extruding the mixture to form a hollow fiber. The hollow fiber may be formed by extrusion through an annular extrusion die, essentially as described hereinabove, e.g., with reference to method 100 (FIG. 1).

The annulus of the extrusion die may have an outside diameter typically in the range of from about 900 to 2000 microns, usually from about 1000 to 1600 microns, and often from about 1100 to 1500 microns. The annulus of the extrusion die may have an inside diameter typically in the range of from about 500 to 1000 microns, usually from about 600 to 900 microns, and often from about 650 to 800 microns. The annulus of the extrusion die may have an outside diameter to inside diameter ratio typically in the range of from about 1.1 to 4.0, usually from about 1.5 to 2.0, and often from about 1.6 to 1.8. Step 306 may involve feeding a core liquid into the hollow fiber. The core liquid may be fed into the hollow fiber essentially as described hereinabove, e.g., with reference to step 106, method 100 (FIG. 1).

Step 308 may involve passing the hollow fiber through a gaseous quench zone. The gaseous quench zone may comprise air at ambient temperature. The gaseous quench zone may be adapted to promote or maximize loss of both solvent and non-solvent from the hollow fiber. The gaseous quench zone may comprise dry air having a −40° C. dew point. The gaseous quench zone may have a height (length) typically in the range of from about 8 to 60 cm, usually from about 10 to 50 cm, and often from about 20 to 50 cm. While not being bound by theory, applicant believes that the rapid loss of solvent and/or non-solvent from the hollow fiber that occurs in a gaseous quench zone comprising dry air having a −40° C. dew point may be an important factor in determining the structure of both porous and non-porous (skin) layers of the hollow fiber walls (i.e., membrane).

Step 308 may involve passing the hollow fiber through a liquid quench zone. The liquid quench zone may comprise water at 4° C. to ambient temperature. Step 308 may involve passing the hollow fiber through the liquid quench zone such that the hollow fiber has a residence time typically less than about 1 minute. The residence time of the hollow fiber in the liquid quench zone may usually be in the range of from about 1 to 50 sec, more usually from about 1 to 10 sec, and often from about 1 to 5 sec.

Step 312 may involve washing the hollow fiber. As an example, step 312 may be performed essentially as described hereinabove, e.g., with reference to step 206, method 200 (FIG. 2). Prior to washing the hollow fiber, the hollow fiber may be drawn down by winding the hollow fiber on a spool. The hollow fiber may be drawn down at a line speed typically in the range of from about 30 to 60 m/min (or about 100 to 250 feet per minute), usually from about 40 to 55 m/min, and often from about 44 to 55 m/min. The diameter of the hollow fiber may be adjusted by the rate of draw down.

Steps 314-318 may be performed essentially as described hereinabove, e.g., with reference to steps 208-212, method 200 (FIG. 2). The hollow fiber prepared according to the instant invention may have an internal (inside) diameter typically in the range of from about 80 to 250 microns, usually from about 90 to 200 microns, and often from about 100 to 150 microns. The hollow fiber prepared according to the instant invention may have an external (outside) diameter typically in the range of from about 120 to 350 microns, usually from about 120 to 250 microns, and often from about 120 to 200 microns.

The hollow fiber prepared according to the instant invention may have an oxygen/nitrogen selectivity (or separation factor) of at least about 2, typically at least about 4, often at least about 6, and in some embodiments an oxygen/nitrogen selectivity of about 12. (As is known in the art, the oxygen/nitrogen selectivity is a measure of the ratio of oxygen flux to nitrogen flux at the same temperature.) The hollow fiber prepared according to the instant invention may have an oxygen flux at ambient temperature of greater than about 2 GPU (gas permeation units), and in some embodiments greater than 3 GPU.

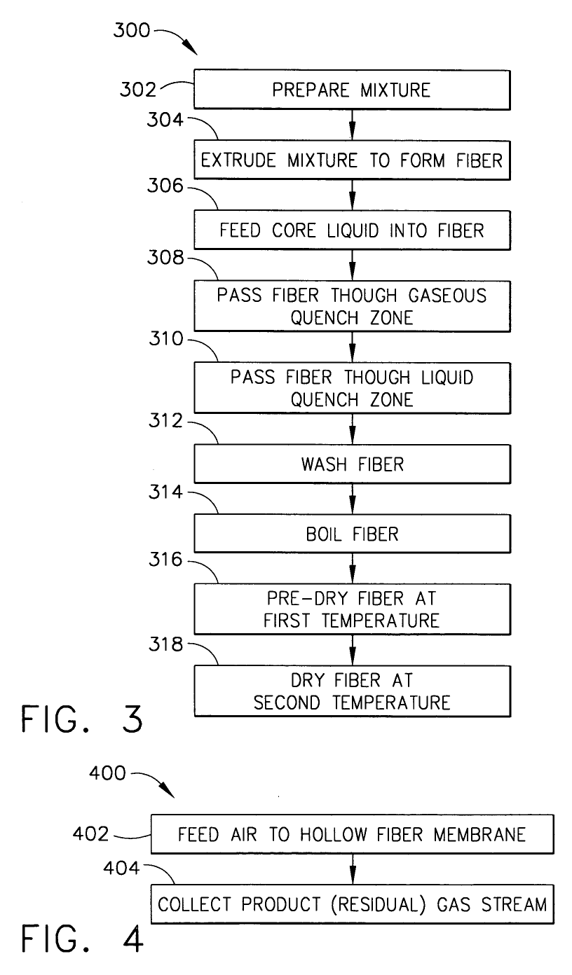

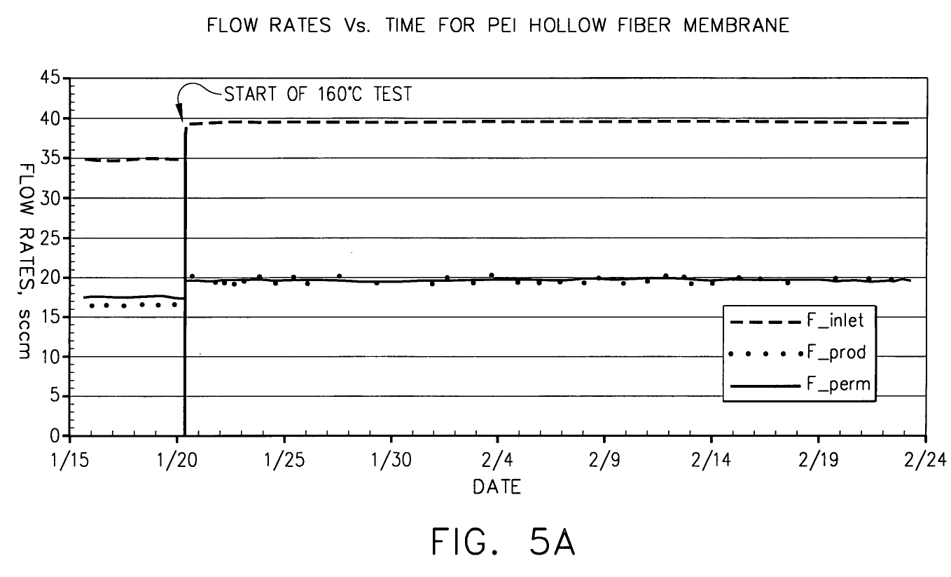

FIG. 4 schematically represents a series of steps involved in a method for separating a gas, according to another embodiment of the invention. Step 402 may involve feeding air to a gas separation membrane of the instant invention. The air fed to the gas separation membrane may be compressed air. The compressed air may be bleed air from a gas turbine engine. The gas turbine engine may be onboard an aircraft. The compressed air may be fed to the gas separation membrane directly from a precooler. The bleed air flowing from the precooler may be at a temperature typically in the range of from about 150 to 160° C. Hollow fiber gas separation membranes of the invention are stable within this temperature range. The gas separation membrane may be in the form of a hollow fiber, for example, as described with reference to FIGS. 1-3. The gas separation membrane may be installed in an ASM of an OBIGGS. The ASM may be of tube-and-shell construction. Due to the temperature stability of gas separation membranes of the invention, the OBIGGS may optionally lack a heat exchanger, or may possess reduced heat exchanger capacity, thereby not only simplifying the OBIGGS but also decreasing its weight and size.

Step 402 may involve feeding the bleed air into the bore of the hollow fibers, i.e., using internal (boreside) feed mode. Alternatively, the hollow fibers of the invention may also be used in external feed mode.

The air (i.e., feed or inlet gas) fed to the hollow fibers may be separated into a permeate stream having an elevated oxygen concentration, and a product (residual) stream having a depleted oxygen concentration, such that the product stream comprises NEA. Step 404 may involve collecting the product stream separately from the permeate stream. The product stream comprising NEA may have an oxygen concentration less than about 12% by volume, and often less than about 11% oxygen by volume. As an example, the product stream of NEA may be fed to the fuel tanks of the aircraft to prevent, or minimize the risk of, a fuel tank explosion.

In some embodiments, the NEA may be used to drive a turbine, wherein energy used for compressing the air fed to the OBIGGS may be partially recovered, and at the same time the NEA may be cooled prior to distribution to the fuel tanks.

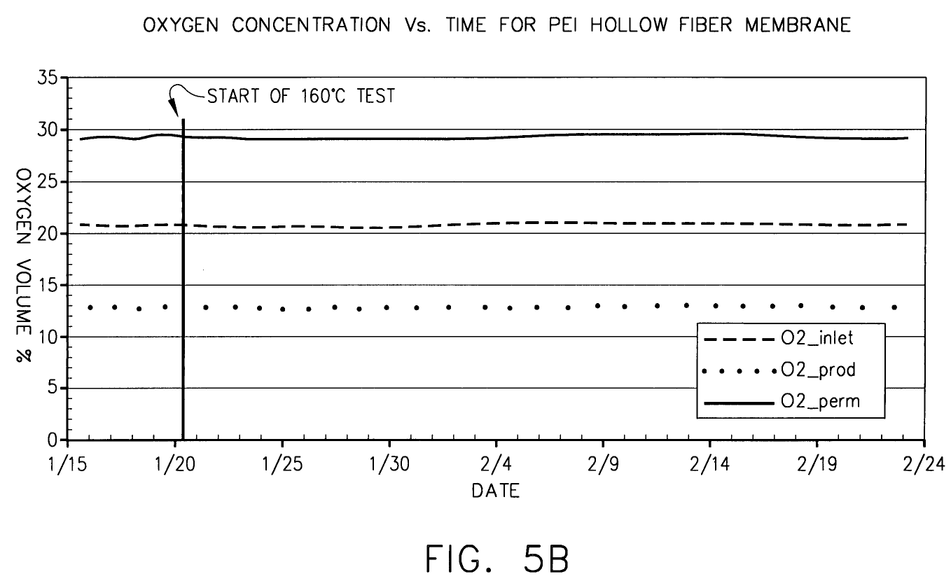

FIG. 5A is a graph showing the inlet flow rate (F_inlet), product flow rate (F_prod), and permeate flow rate (F_perm) as recorded during a period of 34 days (commencing on 1/20) during which a polyetherimide (PEI) hollow fiber membrane prepared according to the instant invention was exposed to a temperature of 160° C. It is apparent that all three flow rates were essentially unchanged following such heat exposure. Thus, FIG. 5A indicates that the hollow fiber membrane of the instant invention is stable at temperatures of at least about 160° C.

FIG. 5B is a graph showing inlet oxygen concentration (O_{2—}inlet), product (residual) oxygen concentration (O_{2—}prod), and permeate oxygen concentration (O_{2—}perm) for a polyetherimide (PEI) hollow fiber membrane of the instant invention during exposure to a temperature of 160° C. for a period of 34 days (commencing on 1/20). It is readily apparent that all three oxygen concentrations were essentially unchanged following such heat exposure. Thus, FIG. 5B further demonstrates that the hollow fiber membrane of the instant invention is stable at temperatures of at least about 160° C. It is to be understood that the data of FIG. 5B is presented merely to illustrate the heat stability of gas separation hollow fiber membranes of the invention, and should not be construed as limiting the invention in any way.

### EXAMPLES

### Example 1

A mixture of 30% by weight polyetherimide (PEI), 58.2% by weight N-methyl pyrrolidone (NMP, solvent), and 11.8% by weight ethanol (non-solvent), (solvent to non-solvent ratio of 4.9) was placed in a 500 ml plastic bottle and shaken at 100 rpm on a reciprocating shaker at 70° C. overnight. The mixture was then de-bubbled and extruded through a spinnerette at a rate of 1.9 g/min. The mixture was kept at 90° C. and the surface of the spinnerette was kept at 75° C. The mixture was extruded through an annulus (684 microns inside diameter and 1194 microns outside diameter) with a core fluid pin feeding a core liquid comprising 42% by weight NMP and 58% by weight ethanol at a rate of 0.9 ml/min. The line speed was 120 ft/min. The extruded hollow fiber was passed through an air quench zone having a height of 25 cm. at ambient temperature. The fiber was then passed through a liquid quench bath of ambient temperature tap water with a residence time of 2 seconds. The fiber was wound on a spool and washed with tap water for 12 hours. The fibers were then boiled in deionized water for 10 minutes, pre-dried in an oven at 90° C. for 2 hours, and dried at 160° C. overnight. The fiber thus prepared had an outside diameter of about 300 microns and an inside diameter of about 200 microns. The fibers thus prepared have a porous inner surface and an outer skin layer which separates oxygen from nitrogen as demonstrated by the test results.

After drying, the fibers were tested for permeation properties. The fibers were potted with epoxy into a tube-and-shell style air separation module. Air was fed into the bore of the fiber under pressure and the permeate flow and product (residual) flow were adjusted to be equal, and the resulting oxygen concentration in each stream was recorded. The above fiber was tested at a temperature of 44° C. with a feed pressure of 43 psig. The measured permeate flow rate and residual flow rate were 4.0 ml/min. The permeate stream had an oxygen concentration of 31.65 mole %, while the product (residual) stream had an oxygen concentration of 10.24 mole %.

### Example 2

A mixture of 40% by weight polyetherimide (PEI), 47.4% by weight N-methyl pyrrolidone (NMP, solvent), and 12.6% by weight triethylene glycol (TEG, non-solvent), (solvent to non-solvent ratio of 3.8) was placed in a 2000 ml stirred reactor and stirred at 80° C. for 48 hours. The mixture was then de-bubbled and extruded through a spinnerette at a rate of 2.2 g/min. The mixture was kept at 90° C. and the surface of the spinnerette was kept at 97.5° C. The mixture was extruded through an annulus (684 microns inside diameter and 1194 microns outside diameter) with a core fluid pin feeding a core liquid comprising 50% by weight NMP and 50% by weight TEG at a rate of 1.0 ml/min. The line speed was 200 ft/min. (about 60 m/min.). The extruded hollow fiber was passed through an air quench zone having a height of 40 centimeters at ambient temperature. The fiber was then passed through a liquid quench bath of ambient temperature tap water with a residence time of 1.2 seconds. The fiber was wound on a spool and washed with tap water for 12 hours. The fibers were then boiled in deionized water for 10 minutes, pre-dried in an oven at 90° C. for 2 hours, and dried at 160° C. overnight. The fibers thus prepared have an outside diameter of about 200 microns and an inside diameter of about 150 microns. The fibers thus prepared have a porous inner surface and an outer skin layer which separates oxygen from nitrogen as demonstrated by the following test results.

After drying, the fibers were tested for permeation properties. The fibers were potted with epoxy into a tube-and-shell style air separation module. Air was fed into the bore of the fiber under pressure and the permeate flow and residual (product) flow were adjusted to be equal. The resulting oxygen concentration in each stream was recorded. The fiber was tested at a temperature of 150° C. with a feed pressure of 43 psig. The measured flow rate and residual flow rate were 4.7 ml/min. The permeate stream had an oxygen concentration of 30.36 mole %, while the residual (product) stream had an oxygen concentration of 11.48 mole %.

### Example 3

A polyetherimide hollow fiber gas separation membrane prepared according to the instant invention (e.g., as described hereinabove with respect to FIGS. 1-3) was exposed to a temperature of 150° C., and the inlet flow rate, product flow rate, and permeate flow rate were recorded over time. On the date shown as 1/20 (FIG. 5A), the temperature was raised to 160° C., and thereafter the temperature was maintained at 160° C. The inlet flow rate, product flow rate, and permeate flow rate were essentially constant over the following 34 days. The results shown in FIG. 5A indicate that the hollow fiber of the instant invention is stable at temperatures of at least about 160° C.

### Example 4

A polyetherimide hollow fiber gas separation membrane prepared according to the instant invention (e.g., as described hereinabove with respect to FIGS. 1-3) was exposed to a temperature of 150° C. On the date shown as 1/20 (FIG. 5B), the temperature was raised to 160° C., and the temperature was maintained at 160° C. thereafter. The inlet oxygen concentration, product oxygen concentration, and permeate oxygen concentration were recorded over the following 34 days. The oxygen concentrations for each of the inlet gas, product gas, and permeate gas were found to be essentially constant during exposure to 160° C. for the entire 34 day period. The results shown in FIG. 5B show that the hollow fiber of the instant invention is heat stable, and fully retains its gas separation capability following prolonged exposure to temperatures of at least about 160° C.

It should be understood, of course, that the foregoing relates to exemplary embodiments of the invention and that modifications may be made without departing from the spirit and scope of the invention as set forth in the following claims.

We claim:

1. A method for preparing a gas separation membrane, comprising:
a) preparing a mixture, wherein said mixture comprises a polymer, a solvent, and a non-solvent;
b) forming a hollow fiber from said mixture; and
c) feeding a core liquid within the bore of said hollow fiber, wherein said membrane is heat stable to a temperature of at least about 160° C., and said membrane has an oxygen/nitrogen selectivity of at least about 2.

2. The method of claim 1, wherein said step b) comprises extruding said mixture through an annulus.

3. The method of claim 2, wherein said step b) comprises extruding said mixture at a rate of about 1 to 3 gram per minute.

4. The method of claim 2, wherein said annulus has an outside diameter to inside diameter ratio in the range of from about 1.1 to 2.5.

5. The method of claim 2, wherein said annulus has an outside diameter of from about 1000 to 1500 microns, and an inside diameter of from about 600 to 800 microns.

6. The method of claim 1, wherein said solvent comprises N-methyl pyrrolidone, dimethylformamide, or dimethylacetamide, and said non-solvent comprises methanol, ethanol, isopropanol, acetic acid, water or triethylene glycol.

7. The method of claim 1, wherein a wt % ratio of said solvent to said non-solvent is in the range of from about 3.0 to 6

8. The method of claim 1, wherein said step c) comprises feeding said core liquid at a flow rate of about 0.5 to 1.0 ml per minute.

9. The method of claim 1, wherein said core liquid comprises N-methyl pyrrolidone/water, and wherein a wt % ratio of N-methyl pyrrolidone to water is in the range of from about 50:50 to 99:1.

10. The method of claim 1, wherein said core liquid comprises N-methyl pyrrolidone/triethylene glycol, and wherein a wt % ratio of N-methyl pyrrolidone to triethylene glycol is in the range of from about 50:50 to 95:5.

11. The method of claim 1, further comprising:
d) after said step c), passing said hollow fiber though a gaseous quench zone comprising dry air at ambient temperature.

12. The method of claim 11, wherein said gaseous quench zone has a height of from about 10 to 50 cm.

13. The method of claim 11, further comprising:
e) after said step d), drying said hollow fiber at a temperature of about 160° C.

14. The method of claim 1, wherein said polymer comprises polyetherimide.

15. The method of claim 1, wherein said gas separation membrane is heat stable to a temperature of at least about 160° C. for a period of at least about 34 days, and said membrane has an oxygen/nitrogen selectivity of at least about 4.

16. The method of claim 15, wherein said gas separation membrane has an oxygen/nitrogen selectivity of at least about 6, and an oxygen flux of at least about 2 GPU.

17. A method for preparing a gas separation membrane, comprising:
a) preparing a mixture, wherein said mixture comprises polyetherimide, a solvent, and a non-solvent;
b) extruding said mixture through an annulus of an extrusion die to form a hollow fiber comprising said polyetherimide;
c) feeding a core liquid within the bore of said hollow fiber, wherein said core liquid is selected from the group consisting of at least one of N-methyl pyrrolidone/water and N-methyl pyrrolidone/triethylene glycol;
d) passing said hollow fiber through a gaseous quench zone of dry air at ambient temperature;
e) thereafter, passing said hollow fiber through a liquid quench zone;
f) thereafter, boiling said hollow fiber in water; and
g) drying said hollow fiber, wherein said gas separation membrane is heat stable at a temperature of at least about 160° C.

18. The method of claim 17, wherein said step b) comprises extruding said mixture through said annulus at a rate of about 1 to 3 ml/min, and said step c) comprises feeding said core liquid at a flow rate of about 0.5 or 1.0 ml/min.

19. The method of claim 17, wherein said dry air of said gaseous quench zone has a −40° C. dew point.

20. The method of claim 17, wherein said step f) comprises boiling said hollow fiber in water for a period of from about 5 to 15 minutes.

21. The method of claim 17, wherein said step g) comprises drying said hollow fiber at a temperature of about 160° C., and the method further comprises:
h) prior to said step g), pre-drying said hollow fiber at a temperature of about 90° C.

22. The method of claim 17, wherein said gas separation membrane has an oxygen/nitrogen selectivity of at least about 4, and an oxygen flux of at least about 2 GPU.

23. A method for preparing a gas separation membrane, comprising:
a) preparing a mixture including polyetherimide, a solvent, and a non-solvent;
b) extruding said mixture through an annulus of an extrusion die to form a hollow fiber comprising said polyetherimide;
c) concurrently with said extruding step, feeding a core liquid within said annulus, such that said core liquid enters the bore of said hollow fiber and said core liquid contacts the internal surface of said hollow fiber;
d) passing said hollow fiber through a gaseous quench zone of dry air at ambient temperature, wherein said gaseous quench zone is adapted to promote loss of both said solvent and said non-solvent from the external surface of said hollow fiber;
e) thereafter, passing said hollow fiber through a liquid quench zone of water at ambient temperature;
f) thereafter, washing said hollow fiber with water;
g) thereafter, boiling said hollow fiber in water;
h) pre-drying said hollow fiber at a first temperature; and
i) drying said hollow fiber at a second temperature, said second temperature higher than said first temperature, wherein:
the walls of said hollow fiber comprise said gas separation membrane,
said gas separation membrane has an inner porous layer and an outer non-porous layer,
said gas separation membrane is heat stable to a temperature of at least about 160° C., and
said gas separation membrane has an oxygen/nitrogen selectivity of at least about 4.

24. The method of claim 23, wherein:
said solvent comprises N-methyl pyrrolidone, said non-solvent comprises ethanol or triethylene glycol, and a wt % ratio of said solvent to said non-solvent is in the range of from about 3:6; and
said core liquid is selected from the group consisting of N-methyl pyrrolidone/water, N-methyl pyrrolidone/triethylene glycol, dimethylformamide/water, dimethylacetamide/water, and mixtures thereof.

25. The method of claim 23, wherein:
said gaseous quench zone comprises dry air having a −40° C. dew point; and
said hollow fiber has a residence time in said liquid quench zone of from about 1 to 10 sec.

26. The method of claim 23, wherein:
said step f) comprises washing said hollow fiber with water for a period longer than about 10 minutes;
said step g) comprises boiling said hollow fiber in water for a period longer than about 1 minute; and
said second temperature is about 160° C.

27. The method of claim 23, wherein said annulus has an outside diameter to inside diameter ratio in the range of from about 1.5 to 2.0.

28. The method of claim 23, wherein said outer non-porous layer is disposed on the external surface of said hollow fiber.

29. The method of claim 23, wherein said gas separation membrane has an oxygen/nitrogen selectivity of about 12.

30. A method for treating a hollow fiber gas separation membrane, comprising:
a) feeding a core liquid within the bore of said hollow fiber;
b) quenching said hollow fiber;
c) boiling said hollow fiber in water;
d) pre-drying said hollow fiber at a first temperature above ambient temperature; and
e) drying said hollow fiber at a second temperature, wherein:
said first temperature is less than said second temperature, and
said gas separation membrane is heat stable to a temperature of at least about 160° C.

31. The method of claim 30, wherein said step b) comprises passing said hollow fiber through at last one quench zone, wherein said at least one quench zone is adapted to promote loss of both said solvent and said non-solvent from the external surface of said hollow fiber.

32. The method of claim 31, wherein said at least one quench zone comprises a gaseous quench zone comprising ambient temperature dry air having a −40° C. dew point.

33. The method of claim 30, wherein said hollow fiber is formed by extrusion through an annular extrusion die, and wherein said step a) is performed concurrently with, or immediately after, extrusion of said hollow fiber.

34. The method of claim 30, wherein said second temperature is about 160° C.

35. The method of claim 30, wherein said gas separation membrane has an oxygen/nitrogen selectivity of at least about 8.

36. A gas separation membrane, comprising:
at least one hollow fiber comprising a polymer, wherein:
said hollow fiber includes a non-porous external layer and a porous internal layer,
said gas separation membrane has an oxygen/nitrogen selectivity of at least about 4 and an oxygen flux of at least about 2 GPU, and
said gas separation membrane is heat stable to a temperature of at least about 160° C. for a period of at least about 34 days.

37. The gas separation membrane of claim 36, wherein
said gas separation membrane comprises polyetherimide.

38. The gas separation membrane of claim 36, wherein said hollow fiber has an internal diameter of from about 90 to 200 microns.

39. The gas separation membrane of claim 36, wherein said hollow fiber has an external diameter of from about 120 to 250 microns.

40. The gas separation membrane of claim 36, wherein said outer non-porous layer is disposed on the external surface of said hollow fiber.

41. A gas separation membrane prepared according to the method of claim 1, wherein:
the walls of said hollow fiber comprise said gas separation membrane, and
said hollow fiber has a non-porous external layer and a porous internal layer.

42. A gas separation membrane prepared according to the method of claim 23.

43. A method for separating gas via a gas separation membrane of an OBIGGS, comprising:
a) feeding air to said gas separation membrane of said OBIGGS to provide a product stream and a permeate stream; and
b) collecting said product stream separately from said permeate stream, wherein:
said gas separation membrane has an oxygen/nitrogen selectivity of at least about 4 and an oxygen flux of at least about 2 GPU, and
said gas separation membrane is heat stable at a temperature of at least about 160° C.

44. The method for separating gas according to claim 43, wherein said air comprises bleed air from a gas turbine engine.

45. The method for separating gas according to claim 44, wherein said step a) comprises feeding said bleed air directly from a precooler to said gas separation membrane.

46. The method for separating gas according to claim 43, wherein said air is fed directly to said gas separation membrane at a temperature of from about 150 to 160° C.

47. The method for separating gas according to claim 43, wherein said product stream comprises nitrogen enriched air (NEA) having an oxygen concentration less than about 12% by volume.
